(19) United States
(12) Patent Application Publication
(10) Pub. No.: US 2015/0287524 A1
(43) Pub. Date: Oct. 8, 2015

(54) Transformer

(71) Applicant: Hitachi, Ltd., Tokyo (JP)

(72) Inventors: Yasunori ONO, Tokyo (JP); Takahide MATSUO, Tokyo (JP); Naoya MIYAMOTO, Tokyo (JP); Hideki OGATA, Tokyo (JP); Kenichi KAWAMURA, Tokyo (JP)

(21) Appl. No.: 14/600,144

(22) Filed: Jan. 20, 2015

(30) Foreign Application Priority Data
Apr. 3, 2014 (JP) 2014-076616

(51) Int. Cl. H01F 27/36; H01F 27/245; H01F 27/26

(52) U.S. Cl. CPC H01F 27/365; H01F 27/263; H01F 27/245

(57) ABSTRACT

A loss in iron core clamping structures and a tank, which is caused by a leakage magnetic flux from a winding between the iron core clamping structures is reduced. In a transformer including an iron core having legs and yokes, windings wound around the legs, and ion core clamping structures arranged above and below the windings to fixedly clamp the iron core, a magnetic shield made of a material high in magnetic permeability is arranged between ends of the iron core clamping structures and the windings on a high voltage side and a low voltage side. The magnetic shield is held by a mounting member held by the ends of the iron core clamping structures in the axial direction thereof.

### BACKGROUND OF THE INVENTION

1. Field of the Invention

The present invention relates to a transformer, and more particularly to a structure of a magnetic shield disposed in an iron core clamping structure of the transformer.

2. Description of the Related Art

In a transformer including an iron core having legs and yokes, and windings wound around the legs, if a large ion core is used, the ion core is clamped from both sides thereof in a lamination thickness direction by upper and lower ion core clamping structures to firmly hold an iron core shape, and the windings are held by the aid of those clamping structures. A transformer main part including the iron core and the windings is fixed within a tank.

A leakage magnetic flux from the windings is introduced into the iron core, the iron core clamping structures, and a side surface and a top surface of the tank. A portion into which a larger amount of leakage magnetic flux is introduced is different depending on a leakage magnetic flux generation position.

The leakage magnetic flux in a direction perpendicular to the iron core clamping structures is introduced into the iron core as well as the iron core clamping structures and the tank. An eddy current loss is generated mainly in the iron core clamping structures and the tank. The leakage magnetic flux between the iron core clamping structures is introduced into the iron core and the tank, and the eddy current loss is generated mainly in the tank.

In recent years, in order to reduce the manufacturing costs, there is a tendency to downsize a transformer, and increase the leakage magnetic flux density. In order to reduce the loss caused by the leakage magnetic flux, it is desirable to reduce the loss in the iron core clamping structures and the tank.

For the purpose of reducing the eddy current loss in the iron core clamping structures and the tank, a nonmagnetic shield and/or a magnetic shield are used. The magnetic shield is frequently prepared by stacking plural silicon steels on each other.

JP-A-11-283848 discloses a method of arranging a magnetic shield member electrically short-circuited so as to surround a yoke in order to reduce a leakage magnetic flux penetrating to the tank from the winding.

Also, JP-A-61-099314 discloses a structure in which a magnetic shield having an annular circular shape in which an insulator is inserted between ferromagnetic layers is arranged between an upper end and a lower end of the winding, and the iron core clamping structures.

Also, JP-A-02-148811 discloses a structure in which a magnetic shield having an annular circular shape is arranged between an upper end and a lower end of the winding, and the iron core clamping structures, and a magnetic shunt is released on a surface opposite to a surface facing the winding.

In the structure of JP-A-11-283848, an eddy current flows in the magnetic shield member electrically short-circuited so as to cancel the leakage magnetic flux from the winding. As a result, the loss in the top surface and the bottom surface of the tank can be reduced to some degree, but there arises such a problem that loss generated in the iron core clamping structures is not always reduced due to a magnetic field produced by the eddy current.

In the structure of JP-A-61-099314, the leakage magnetic flux from the winding penetrates into the magnetic shield of the annular circular shape, but the magnetic flux between the ferromagnetic bodies into which an insulator is inserted is difficult to transfer, and the magnetic flux penetrated into the magnetic shield returns to the iron core through the iron core clamping structures. As a result, there arises such a problem that the loss in the iron core clamping structures is large.

In the structure of JP-A-02-148811, the magnetic shunt made of a high magnetic material is provided on a surface opposite to the surface facing the winding of the magnetic shield having the annular circular shape to facilitate the transfer of the magnetic flux in the magnetic shield in a radial direction more than that in the structure of JP-A-61-099314. However, because most of the magnetic flux returns to the iron core through the iron core clamping structures, there arises such a problem that the loss in the iron core clamping structures is large.

### SUMMARY OF THE INVENTION

The present invention has been made in view of the above problems, and therefore an object of the present invention is to reduce the loss in iron core clamping structures and a tank, which is caused, particularly, by a leakage magnetic flux from a winding between the iron core clamping structures.

In order to solve the above problems, there is provided a technique for reducing the loss in the iron core clamping structures and the tank, which is caused by the leakage magnetic flux from the winding between the iron core clamping structures.

For example, in a transformer including an iron core having legs and yokes, windings wound around the legs, ion core clamping structures arranged above and below the windings to fixedly clamp the iron core, and a magnetic shield made of a material high in magnetic permeability, a mounting member is arranged between the iron core clamping structures, and the magnetic shield made of a material high in magnetic flux density is held by the mounting member.

According to the present invention, the mounting member is arranged between the iron core clamping structures to hold the magnetic shield made of the material high in magnetic flux density, as a result of which the leakage magnetic flux from the windings is introduced into the magnetic shield, and turns to the iron core from the magnetic shield to reduce the loss generated in the tank and the iron core clamping structures.

### BRIEF DESCRIPTION OF THE DRAWINGS

FIG. 1 is a plan view illustrating a transformer main portion according to a first embodiment;

FIG. 2A is a vertically cross-sectional view taken along a line II-II in FIG. 1 and FIG. 2B is a side view viewed from a direction indicated by an arrow in FIG. 1;

FIGS. 3A and 3B are a plan view and a front view illustrating one example of a magnetic shield;

FIGS. 4A and 4B are a plan view and a front view illustrating still another example of a magnetic shield;

FIGS. 5A and 5B are a plan view and a front view illustrating another example of a magnetic shield;

FIGS. 6A and 6B are enlarged diagrams illustrating an example of a mounting member, in which FIG. 6A is a plan view, and FIG. 6B is a side view viewed from a direction indicated by an arrow in the figure;

FIG. 7 is a graph showing the advantages of the present invention;

FIG. 8 is a plan view illustrating a transformer main portion according to a second embodiment;

FIG. 9A is a vertical cross-sectional view taken along a line IX-IX in FIG. 8, and FIG. 9B is a side view when viewed from a direction indicated by an arrow in FIG. 8;

FIGS. 10A and 10B are enlarged diagrams illustrating a second mounting member according to the second embodiment, in which FIG. 10A is a plan view, and FIG. 10B is a side view viewed from a direction indicated by an arrow in the figure;

FIG. 11 is a plan view illustrating a transformer main portion according to a third embodiment; and

FIGS. 12A and 12B are a plan view and a front view illustrating a structure of a magnetic shield.

### DETAILED DESCRIPTION OF THE INVENTION

Hereinafter, embodiments will be described.

### First Embodiment

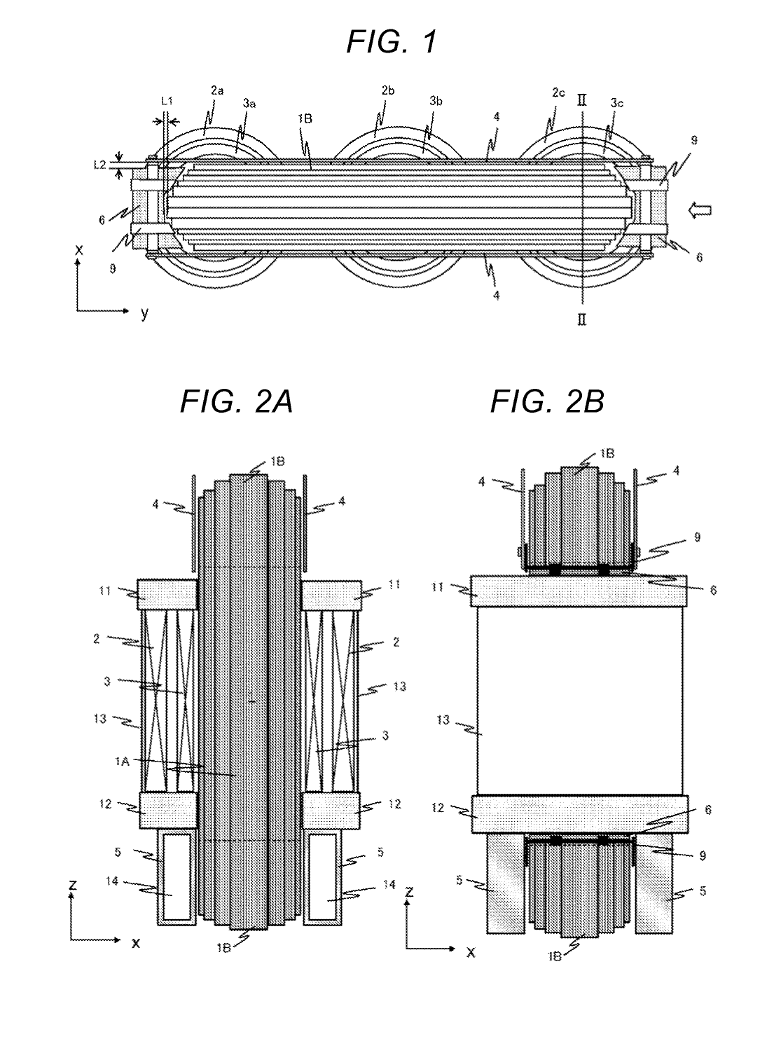

A first embodiment will be described with reference to FIGS. 1 and 2. In this embodiment, a 3-legged three-phase transformer will be exemplified. However, the present invention is not limited to the 3-legged three-phase transformer. FIG. 1 is a plan view illustrating a transformer main portion, FIG. 2A is a vertically cross-sectional view taken along a line II-II in FIG. 1, and FIG. 2B is a side view viewed from a direction indicated by an arrow in FIG. 1;

The transformer main portion includes an iron core 1 having a leg 1A formed by laminating a large number of silicon steels and a yoke 1B, and a high voltage winding 2 and a low voltage winding 3 which are wound around the leg 1A. A cylindrical insulation structure is arranged between or around the respective windings, but is not illustrated except for an outermost cylindrical insulation structure 13. The iron core 1 is fixed with upper iron core clamping structures 4 arranged above the windings, and lower iron core clamping structures 5 arranged below the windings.

A mounting member 9 is arranged between the two upper iron core clamping structures 4 that fix the iron core 1, and a magnetic shield 6 made of a high magnetic permeability material is fixed by the mounting member 9 and an upper insulator 11 arranged on a winding upper portion.

On the other hand, the mounting member 9 is arranged between the lower iron core clamping structures 5, and the magnetic shield 6 made of the high magnetic permeability material is fixed by the mounting member 9 and a lower insulator 12.

Subsequently, a description is made with reference to the plan view of FIG. 1. The upper insulator 11 is arranged between high voltage windings 2a, 2b, 2c as well as low voltage windings 3a, 3b, 3c, and the yoke 1B. However, for facilitating the understanding, the upper insulator 11 will be omitted. The magnetic shield 6 is fixed by the mounting member 9 arranged between the upper iron core clamping structures 4.

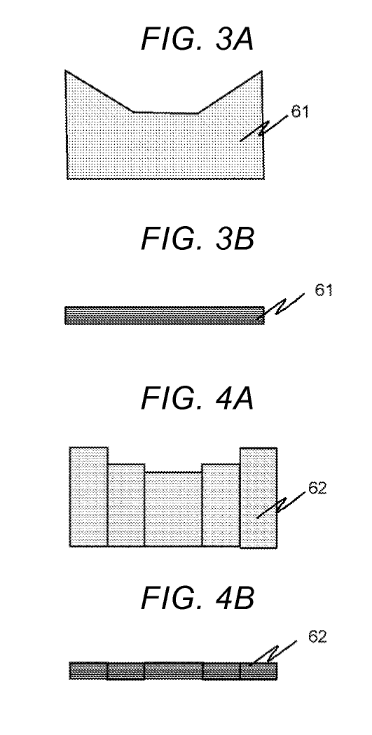

A method of preparing the magnetic shield 6 will be described with reference to FIGS. 3A to 5B. FIGS. 3A, 4A, and 5A illustrate plan views, and FIGS. 3B, 4B, and 5B illustrate front views. FIGS. 3A and 3B illustrate the magnetic shield 6 formed by stacking plural silicon steels 61 made of high magnetic permeability material which are each cut into a shape illustrated in FIG. 3A, and firming the silicon steels 61 with resin.

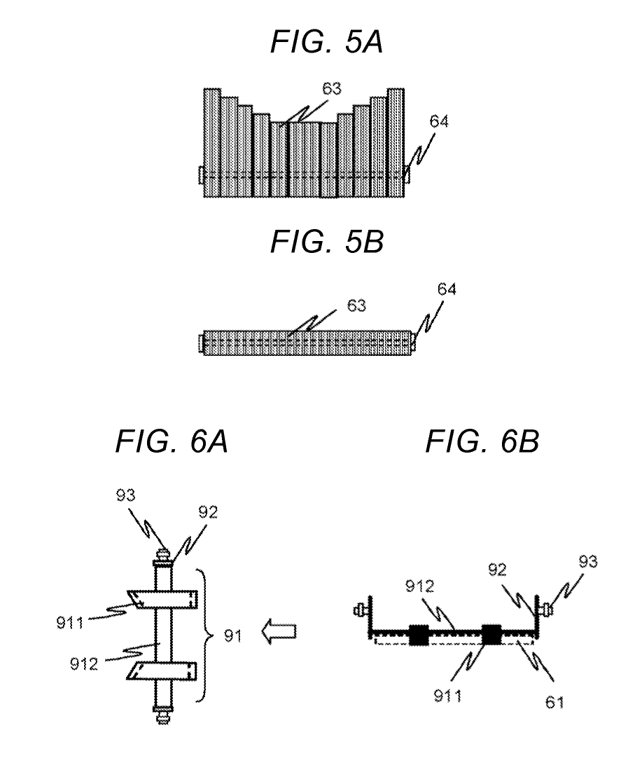

FIGS. 4A and 4B illustrate the magnetic shield 6 configured by arranging plural stacked magnetic shield blocks 62 formed by laminating the silicon steels 61 each cut into a rectangular shape. FIGS. 5A and 5B illustrate a configuration in which plural vertical magnetic shield blocks 63 are combined together, and arranged as illustrated in FIG. 5A. In this situation, the vertical magnetic shield blocks 63 are fixed with a through-type member 64 with the aid of a hole formed in the vertical magnetic shield blocks 63 in advance.

In the above description, the silicon steels are used as the high magnetic permeability material. Alternatively, for example, the magnetic shield 6 shaped as illustrated in FIGS. 3A and 3B can be molded with ferrite. Because a saturation magnetic flux density of ferrite is lower than that of the silicon steel, in order to provide the same function, a volume of the magnetic shield molded with ferrite needs to be larger than a volume of the magnetic shield molded with the silicon steel. However, because a shape of the ferrite is easily machined, the magnetic shield for reducing a gap to the iron core 1 can be formed.

Subsequently, the mounting member will be described in detail. FIGS. 6A and 6B illustrate a structure of the mounting member 9. FIG. 6A is a plan view, and FIG. 6B is a side view when viewed from a direction indicated by an arrow in the figure. The mounting member 9 includes a magnetic shield holding part 91, a vertical support structure 92, and a fixing part for holding support 93. The magnetic shield holding part 91 includes holding members 911 and a horizontal support structure 912. The magnetic shield holding part 91 is different depending on the shape of the magnetic shield 6. The vertical support structure 92 is formed of a rod-like member elongated in a direction perpendicular to a paper plane in the example of FIGS. 6A and 6B. The fixing part for holding support 93 is a member for fixing the magnetic shield holding part 91 to the upper iron core clamping structures 4. The vertical support structure 92 is made of nonmagnetic material (for example, stainless steel).

The magnetic shield 6 is fixedly held between the upper insulator 11 and the magnetic shield holding part 91. The holding members 911 configuring the magnetic shield holding part 91 prevent the magnetic shield 6 from moving in the horizontal direction.

With the above structure, most of the leakage magnetic flux from the windings which is introduced into the magnetic shield 6 flows into the iron core 1 without passing through the upper iron core clamping structures 4, and can prevent the occurrence of loss in the upper iron core clamping structures 4.

With the above-mentioned structure, the leakage magnetic flux between the two upper iron core clamping structures 4 is introduced into the magnetic shield 6. The magnetic flux flowing into the magnetic shield 6 is introduced directly into the iron core 1 by making a distance between the magnetic shield 6 and the iron core 1 smaller than a distance between the magnetic shield 6 and the upper iron core clamping structures 4. For that reason, the loss generated by the magnetic flux penetrated into the tank when the magnetic shield 6 is absent, can be remarkably reduced, and the loss of the transformer internal structure can be reduced.

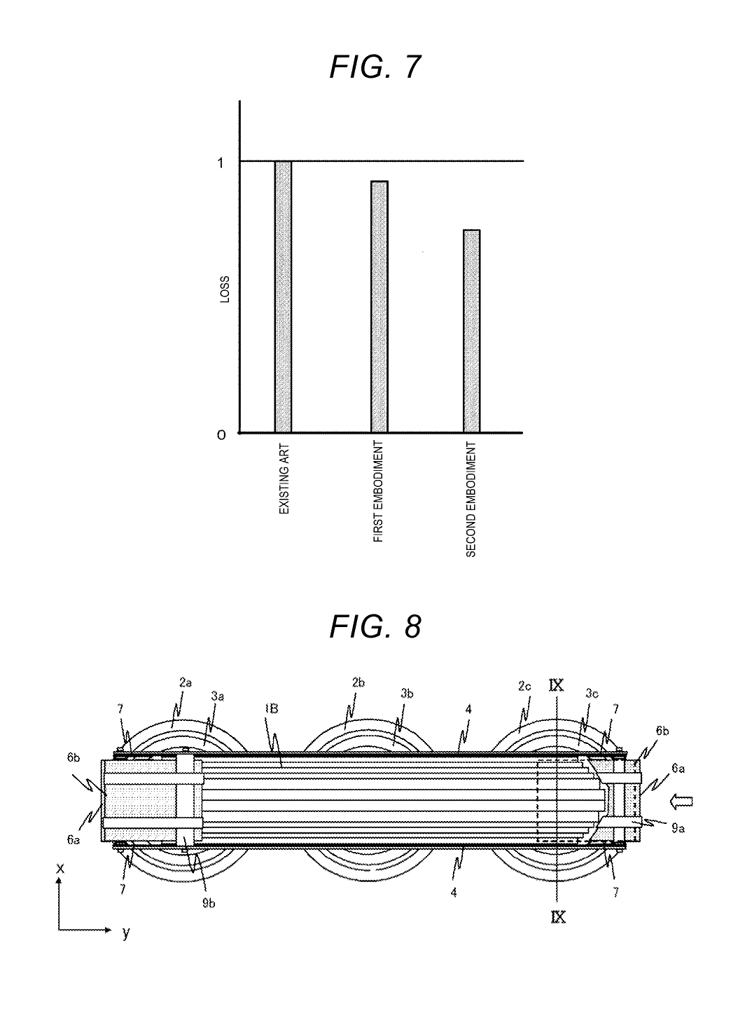

FIG. 7 is a graph showing an influence on the loss of the transformer internal structure due to presence/absence of the magnetic shield, and a difference in the structure of the magnetic shield according to the present invention. When the magnetic shield (refer to FIGS. 1, 2A and 2B) of the first embodiment is used, the loss of the transformer internal structure can be reduced by about 8% as compared with an existing art in which no magnetic shield is used.

The effects of the loss reduction are greatly affected by the mutual positional relationship of the magnetic shield 6, the iron core 1, and the upper iron core clamping structures 4. As illustrated in FIG. 1, it is assumed that a distance between the magnetic shield 6 and the iron core 1 is L1, and a distance between the magnetic shield 6 and the upper iron core clamping structures 4 is L2 in the description.

If L1>L2, that is, if the upper iron core clamping structures 4 is closer to the magnetic shield 6 than the iron core 1, because the magnetic flux penetrated into the magnetic shield 6 returns to the iron core 1 through the upper iron core clamping structures 4, an eddy current loss is generated in the upper iron core clamping structures 4, and the effect of reducing the loss is hardly obtained.

On the other hand, if L1<L2, that is, if the iron core 1 is closer to the magnetic shield 6 than the upper iron core clamping structures 4, because the magnetic flux penetrated into the magnetic shield 6 returns to the iron core 1 without passing through the upper iron core clamping structures 4, the effect of reducing the loss is obtained. The effects of the magnetic shield described with reference to FIG. 7 are results in an arrangement satisfying L1<L2.

### Second Embodiment

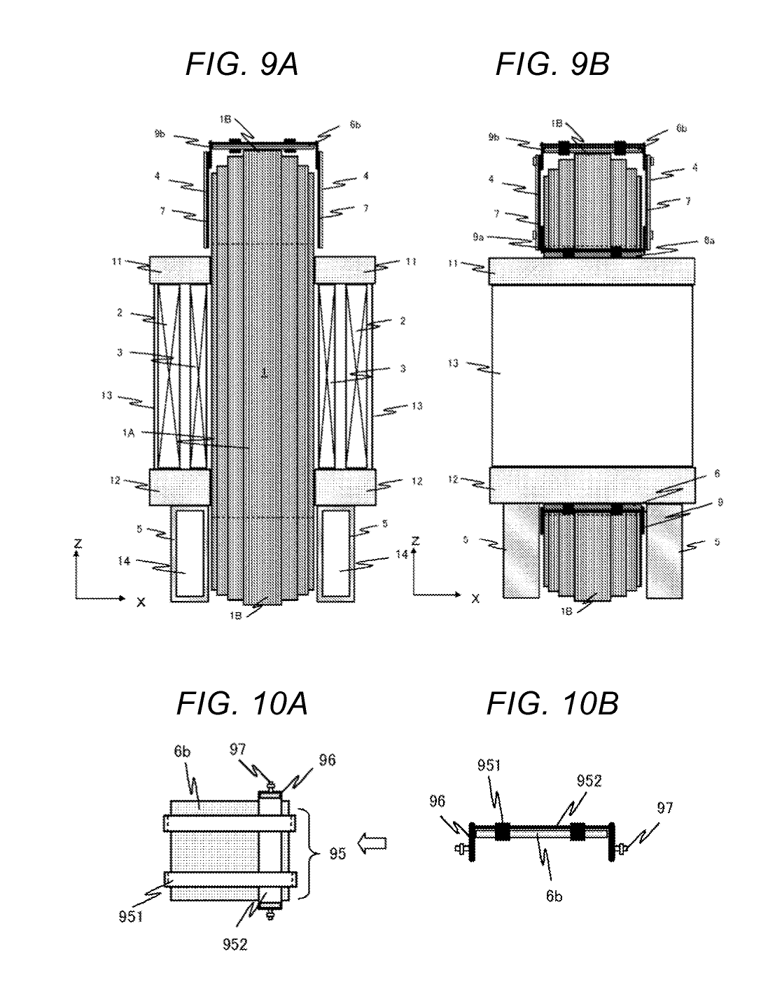

A second embodiment will be described with reference to FIGS. 8, 9A, and 9B. FIG. 8 is a plan view illustrating a transformer main portion, FIG. 9A is a vertical cross-sectional view taken along a line IX-IX in FIG. 1, and FIG. 9B is a side view when viewed from a direction indicated by an arrow in FIG. 8.

Referring to the vertical cross-sectional view of FIG. 9A for description, the iron core, the iron core clamping structures, the windings, and the magnetic shield arranged below are identical with those in the first embodiment. This embodiment is different from the first embodiment in that a nonmagnetic shield 7 is arranged on the iron core side of the upper iron core clamping structures 4, and a second magnetic shield 6b is fixed to a position that substantially contacts with an upper portion of the yoke 1B with the aid of a second mounting member 9b.

That is, the features of the second embodiment reside in that, in addition to the configuration described in the first embodiment, the nonmagnetic shield 7 is disposed on ends of the upper iron core clamping structures 4 in the axial direction, which are arranged on the upper side of the windings, which is a surface facing the yoke 1B, and another magnetic shield 6b made of a high magnetic permeability material is disposed on an upper end side of the ends of the upper iron core clamping structures 4 in the axial direction

Hereinafter, a layout of the mounting member and the magnetic shield will be described with reference to FIG. 8 (plan view). A phase on a left side of FIG. 8 illustrates first and second mounting members, and first and second magnetic shields whereas a phase on a right side thereof illustrates only the first mounting member and the first magnetic shield except for the second mounting member and the second magnetic shield (dashed part).

A first mounting member 9a and a first magnetic shield 6a are identical with those in the first embodiment. The second mounting member 9b will be described with reference to FIGS. 10A and 10B. FIGS. 10A and 10B are enlarged diagrams illustrating a structure of the second mounting member 9b. FIG. 10A is a plan view, and FIG. 10B is a side view when viewed from a direction indicated by an arrow in the figure.

The second mounting member 9b includes a magnetic shield storage member 95 that stores the second magnetic shield 6b, a storage support member 96, and a fixing part for storage support 97. The storage support member 96 is made of a nonmagnetic material. The storage support member 96 is fixed to the upper iron core clamping structures 4 with the fixing part for storage support 97.

The magnetic shield storage member 95 includes a holding member 951 and a horizontal support structure 952. The holding member 951 is of a structure forming a closed path. The second magnetic shield 6b is held in a space surrounded by the holding member 951 and the horizontal support structure 952.

With the above structure, the leakage magnetic flux between the upper iron core clamping structures 4 and the lower iron core clamping structures 5 in the leakage magnetic flux from the windings is introduced into the iron core 1 through the first magnetic shield 6a. A part of the leakage magnetic flux is penetrated into the upper iron core clamping structures 4, but repelled by the nonmagnetic shield 7, and introduced into the second magnetic shield 6b. Therefore, the loss of the tank does not increase. Therefore, the loss in the transformer internal structure can be remarkably reduced.

As illustrated in FIG. 7, when the magnetic shield (refer to FIGS. 8, 9A, and 9B) in the second embodiment is used, the loss of the transformer internal structure can be reduced by about 26% as compared with the existing art in which the magnetic shield is not used.

### Third Embodiment

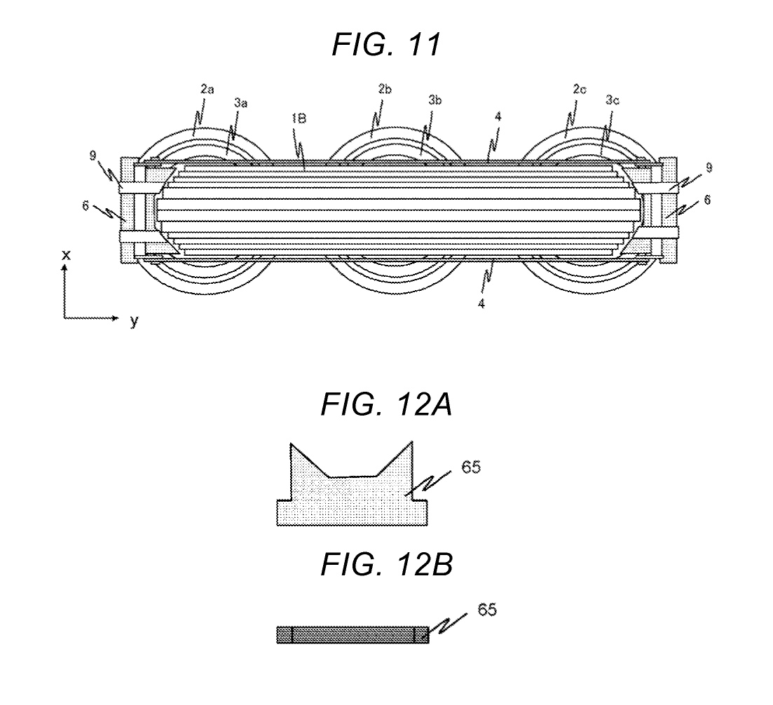

A third embodiment will be described with reference to FIGS. 11, 12A and 12B. FIG. 11 is a top view illustrating a transformer main portion. The configuration of this embodiment is substantially identical with that in the first embodiment (FIG. 1), but the shape of the magnetic shield 6 is different from that in the first embodiment.

The magnetic shield 6 according to this embodiment is formed by stacking silicon steels 65 each cut into a shape illustrated in FIG. 12A, and firming the silicon steels 65 with resin. A side of the magnetic shield 6 closer to the yoke 1B is arranged between the upper iron core clamping structures 4, but a side of the magnetic shield 6 farther from the yoke 1B is arranged to protrude from between the upper iron core clamping structures 4 toward the external.

With the above structure, the more extensive leakage magnetic flux can be introduced into the magnetic shield 6, and the loss of the transformer internal structure such as the tank can be reduced.

What is claimed is:

1. A transformer including an iron core having legs and yokes, windings wound around the legs, and ion core clamping structures arranged above and below the windings to fixedly clamp the iron core,
wherein at least one magnetic shield made of a material high in magnetic permeability is arranged between ends of the iron core clamping structures in the axial direction thereof, and the windings.

2. The transformer according to claim 1,
wherein the at least one magnetic shield is held by a retention member held between the ends of the iron core clamping structures in the axial direction thereof.

3. The transformer according to claim 1, further comprising:
at least one nonmagnetic shield, facing the yokes, disposed on the ends of the iron core clamping structures in the axial direction thereof, the iron core clamping structures being arranged on an upper side of the windings; and
at least another magnetic shield made of a material high in magnetic permeability disposed on an upper side at the ends of the iron core clamping structures in the axial direction thereof.

4. The transformer according to claim 2,
further comprising: at least one nonmagnetic shield, facing the yokes, disposed on the ends of the iron core clamping structures in the axial direction thereof, the iron core clamping structures being arranged on an upper side of the windings; and
at least another magnetic shield made of a material high in magnetic permeability disposed on an upper side at the ends of the iron core clamping structures in the axial direction thereof.

5. The transformer according to claim 4,
wherein the another magnetic shield is held by a retention member held between the upper side at the ends of the iron core clamping structures in the axial direction thereof.

6. The transformer according to claim 1,
wherein a distance between the magnetic shield and the iron core is smaller than a distance between the magnetic shield and the iron core clamping structures.
